(19) United States
(12) Patent Application Publication
(10) Pub. No.: US 2016/0156202 A1
(43) Pub. Date: Jun. 2, 2016

(54) BATTERY PACK AND METHOD FOR CONTROLLING THE SAME

(71) Applicant: SAMSUNG SDI CO., LTD., Yongin-si (KR)

(72) Inventor: Ho Sung KIM, Yongin-si (KR)

(21) Appl. No.: 14/951,406

(22) Filed: Nov. 24, 2015

(30) Foreign Application Priority Data
Nov. 27, 2014 (KR) 10-2014-0167451

(51) Int. Cl. H02J 7/00

(52) U.S. Cl. CPC H02J 7/007; H02J 7/0021; H02J 7/0019

(57) ABSTRACT

A battery pack includes a plurality of rechargeable battery units, and a battery management system configured to control charging and discharging of the plurality of battery units, calculate an idle state time of the plurality of battery units by monitoring the plurality of battery units, determine whether a state of charge (SOC) value of a first battery unit of the battery units is within a SOC range, and cause electrical energy to move from the first battery unit to a second battery unit of the battery units, or to move from the second battery unit to the first battery unit, when the idle state time exceeds a reference time, such that SOC values of the first battery unit and the second battery unit are outside of the SOC range.

### CROSS-REFERENCE TO RELATED APPLICATION

This application claims priority to, and the benefit of, Korean Patent Application No. 10-2014-0167451, filed on Nov. 27, 2014, in the Korean Intellectual Property Office, the entire content of which is incorporated herein by reference in its entirety.

### BACKGROUND

1. Field

Embodiments relate to a battery pack, and to a method of controlling the same.

2. Description of the Related Art

Generally, a battery cell is used as an energy source for a mobile device, an electric vehicle, a hybrid vehicle, electricity, and the like. Depending on the type of the external device in which the battery cell is used, the form of the battery cell may change.

Low capacity batteries may be used in small, portable electronic devices, such as mobile phones, notebooks, computers, and camcorders, while large capacity batteries may be used as a power source for driving motors, such as in hybrid or electric vehicles. If long term driving or high electric power driving is required, a large capacity battery module includes a plurality of electrically coupled battery cells to increase output and capacity. A battery module may increase output voltage or output current depending on the number of internally mounted battery cells. A battery pack may be constructed by electronically coupling a plurality of such battery modules.

Each battery cell may include an electrode assembly including an anode and a cathode on respective sides of a separator, a case for internally mounting the electrode assembly, and an electrode terminal electronically coupled to the electrode assembly, and extending to an exterior of the case.

With repeated charging and discharging, life and performance of a battery cell may decrease or deteriorate, and therefore, the battery may not serve as a suitably stable and sufficient power source. Therefore, research is being conducted to decrease performance deterioration of, and to increase a lifespan of, a battery cell to allow for more efficient use of a battery.

### SUMMARY

Embodiments may be realized by providing a battery pack including a plurality of rechargeable battery units, and a battery management system configured to control charging and discharging of the plurality of battery units, calculate an idle state time of the plurality of battery units by monitoring the plurality of battery units, determine whether a state of charge (SOC) value of a first battery unit of the battery units is within a SOC range, and cause electrical energy to move from the first battery unit to a second battery unit of the battery units, or to move from the second battery unit to the first battery unit, when the idle state time exceeds a reference time, such that SOC values of the first battery unit and the second battery unit are outside of the SOC range.

The battery pack may further include a plurality of switch units coupled to respective ones of the plurality of battery units, and a direct current-to-direct current (DC-DC) converter coupled to at least one of the battery units through the switch unit.

The battery management system may be further configured to control the DC-DC converter, and control the switch units to cause the electrical energy to move between the first battery unit and the second battery unit.

The battery management system may be further configured to control the switch units such that a first switch unit of the switch units that is coupled to the first battery unit and that is coupled to a first end of the DC-DC converter, and such that a second switch unit of the switch units that is coupled to the second battery unit and that is coupled to a second end of the DC-DC converter, are turned on to cause the electrical energy to move between the first battery unit and the second battery unit.

The battery management system may be further configured to cause the electrical energy to move from the first battery unit to the second battery unit, or to move from the second battery unit to the first battery unit, after determining that the SOC value of the first battery unit is within the SOC range.

The battery management system may be further configured to calculate a movement amount of the electrical energy that is to be transferred between the first battery unit and the second battery unit.

The battery management system may be further configured to select any one of the plurality of battery units having a SOC value outside of the SOC range as the second battery unit.

The battery management system may be further configured to select a battery unit of the plurality of battery units having a smallest SOC value as the second battery unit, and cause the electrical energy to move from the first battery unit to the second battery unit after determining that the SOC value of the first battery unit is within the SOC range.

The battery management system may be further configured to re-calculate the SOC value of each of the battery units when the SOC value of the first battery unit continues to be within the SOC range after causing the electrical energy to move from the first battery unit to the second battery unit when the second battery unit is fully charged, and re-select a remaining battery unit of the battery units having a smallest SOC value not within the SOC range as the second battery unit.

The battery management system may be further configured to select a battery unit of the battery units having a largest SOC value as the second battery unit, and cause the electrical energy to move from the second battery unit to the first battery unit after determining that the SOC value of the first battery unit is within the SOC range.

The battery management system may be further configured to cause the electrical energy to move to the second battery unit from the first battery unit when an amount of electrical energy stored in the second battery unit is the same or smaller than the calculated movement amount of the electrical energy.

The battery management system may be further configured to cause the electrical energy to move between ones of the battery units having SOC values within the SOC range.

In an embodiment, there is provided a method of controlling a battery pack including a plurality of rechargeable battery units, and a battery management system configured to control charging and discharging of the battery units, the method including determining whether the plurality of battery units are in an idle state by monitoring the plurality of battery units, determining whether one of the battery units has a SOC value within a SOC range, and controlling charging and discharging of the battery units after determining that the one of the battery units has the SOC value within the SOC range by moving electrical energy between the one of the battery units and respective ones of the battery units such that a SOC value of each of the battery units is out of the SOC range when an idle state time of the plurality of battery units exceeds a reference time.

### BRIEF DESCRIPTION OF THE DRAWINGS

Example embodiments will now be described more fully hereinafter with reference to the accompanying drawings, wherein:

FIG. 1 schematically illustrates a battery pack;

FIG. 2 illustrates charging and discharging operations of a battery unit shown in FIG. 1;

FIG. 3 compares battery units having different SOC values, and illustrates a state in which life of a battery unit changes as an idle state of a battery unit is prolonged; and

FIG. 4 is a flow chart illustrating an overall flow of a method for controlling a battery pack according to an embodiment.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

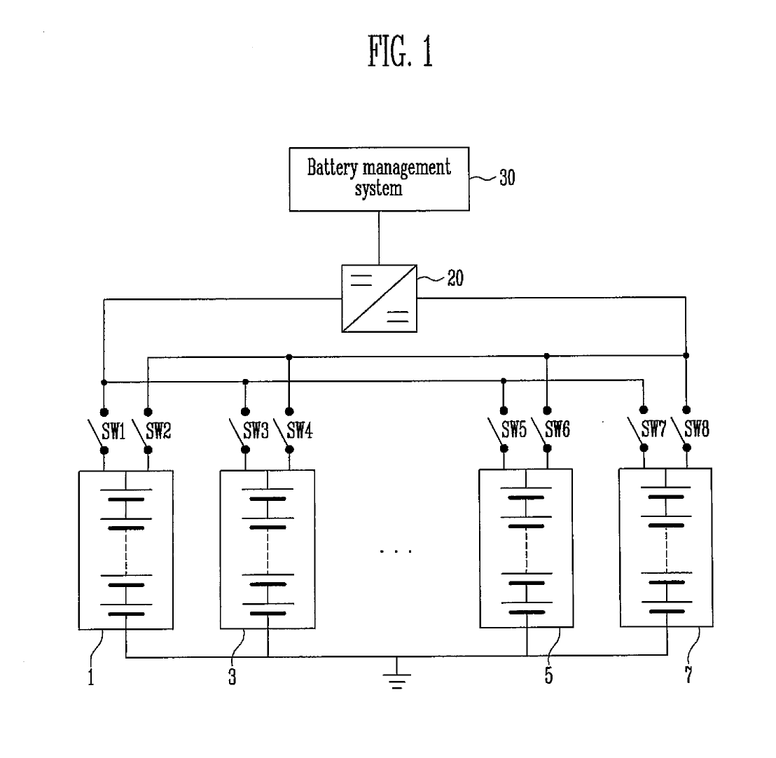

FIG. 1 schematically illustrates a battery pack.

As illustrated in FIG. 1, a battery pack may include a plurality of battery units 1, 3, 5, and 7, a direct current-to-direct current (DC-DC) converter 20, switch units SW1 to SW8 configured to respectively couple the battery units 1, 3, 5, and 7 to ends of the DC-DC converter 20, and a battery management system 30.

The battery units 1, 3, 5, and 7 according to an embodiment may include at least one battery cell each. A secondary/rechargeable battery that is configured to be charged and discharged depending on consumption or supply of electrical energy may be used as the battery cells forming the battery units 1, 3, 5, and 7. For example, a secondary battery may include a nickel-cadmium battery, a lead storage battery, a nickel metal hydride battery, a lithium battery, a lithium polymer battery and the like, although a type of secondary battery of the present embodiment is not limited hereto.

The switch units SW1 to SW8 according to an embodiment may be included at anode terminals of the battery units 1, 3, 5, and 7, while cathode terminals of the battery units 1, 3, 5, and 7 may be coupled to a ground contact part. Some of the switch units SW1, SW3, SW5, and SW7 included at the battery units 1, 3, 5, and 7, respectively, may be coupled to one end of the DC-DC converter 20. The remaining switch units SW2, SW4, SW6, and SW8 included at the battery units 1, 3, 5, and 7, respectively, may be coupled to the other end of the DC-DC converter 20.

FIG. 1 illustrates four battery units provided in a battery pack, although the present invention is not limited hereto. For example, there may be two battery units in the battery pack, such that the battery units may supply and receive electrical energy between each other.

The DC-DC converter 20 according to an embodiment may be a bi-directional converter, and may be switchably coupled to each of the battery units 1, 3, 5, and 7 as the switch units SW1 to SW8 are turned on or off. When the battery units 1, 3, 5, and 7 are discharged, the DC-DC converter 20 may supply a direct current (DC) power of the battery units 1, 3, 5, and 7 to a direct current (DC) link by converting the DC power into a DC power having a different level, or by converting the DC power from the DC link into DC power having a proper level for the battery units 1, 3, 5, and 7, such that the battery units 1, 3, 5, and 7 may be charged. Also, the DC-DC converter 20 may provide DC power of any one of the battery units 1, 3, 5, or 7 shown in FIG. 1 to one or more of the other battery units.

The battery management system 30 according to an embodiment may monitor current flow state, voltage, temperature, and the like of the battery units 1, 3, 5, and 7. The battery management system 30 may calculate a value of a state of charge (SOC) of the battery units using the current, voltage, temperature, and the like of the battery units 1, 3, 5, and 7. The battery management system 30 may control charging and discharging of the battery units 1, 3, 5, and 7 referring to the monitoring results or the calculated SOC value. Particularly, charging and discharging may be controlled by moving electrical energy between respective ones of the battery units 1, 3, 5, and 7.

Also, the battery management system 30 may determine whether the battery units 1, 3, 5, and 7 are in an action state or in an idle state, and may calculate time during which the idle state persists by monitoring the battery units 1, 3, 5, and 7. The battery management system 30 may determine a state in which charging and discharging operations are not performed with respect to the plurality of battery units 1, 3, 5, and 7 as the “idle state,” and may determine a state in which either charging or discharging is performed as the “action state.” The battery management system 30 may control charging and discharging of the plurality of battery units 1, 3, 5, and 7 by referring to SOC values of each of the battery units 1, 3, 5, and 7 when the plurality of battery units 1, 3, 5, and 7 are in the idle state for an idle state time (e.g., idle state time t) that exceeds a reference time T.

The battery management system 30 may determine whether the plurality of battery units 1, 3, 5, and 7 are in the idle state for the idle state time t exceeding the reference time T. If the plurality of battery units 1, 3, 5, and 7 are in the idle state with the idle state time t exceeding the reference time T, the battery management system 30 may move electrical energy from any one of the plurality of battery units 1, 3, 5, and 7 to one or more of the other battery units, and may control charging and discharging of the plurality of battery units 1, 3, 5, and 7.

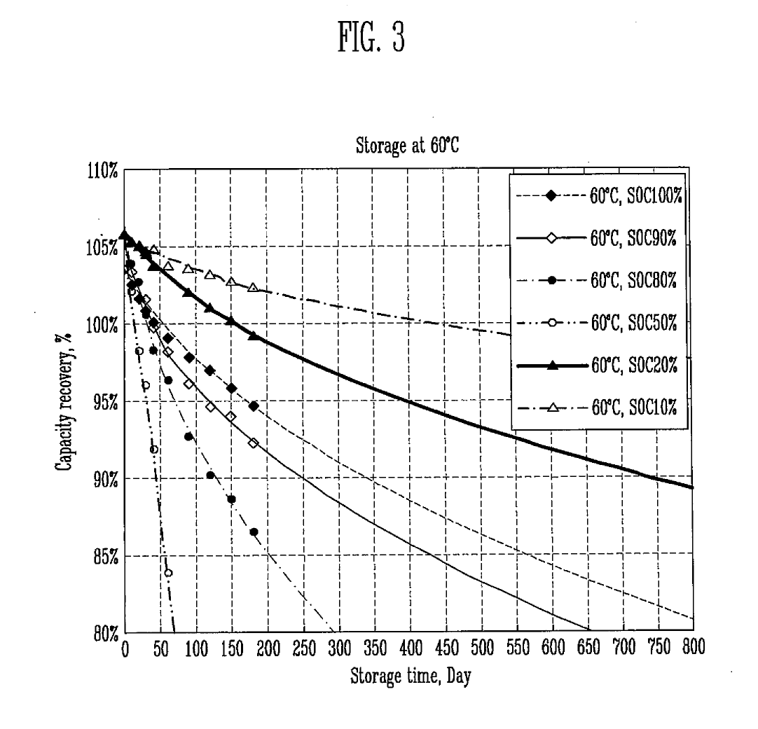

A method of controlling movement of electrical energy between the battery units will be described below. For purposes of convenience, the preset range/scope, which may be referred to as a SOC range, is described as SOC values being from 40% to 60%, although the present invention is not limited thereto. The SOC range may be 50±Δ(%). Depending on desired life of the battery unit, the SOC range may be adjusted by changing the Δ value. Setting the SOC range to be 50±Δ(%) will be described below with reference to FIG. 3.

Although not illustrated in FIG. 1, the battery management system 30 may further include terminals for measuring the current flow state, voltage, temperature, and the like, or for monitoring charging/discharging state or current flow. Although not illustrated in FIG. 1, the battery pack may further include a DC link for temporarily storing DC voltage output from the DC-DC converter or inverter, and may further include an inverter for outputting by converting the DC power provided from the DC link into a commercial alternating current (AC) power source. The battery pack may also include an input/output terminal unit for supplying power of the battery pack as an external load or for receiving power from an external power source.

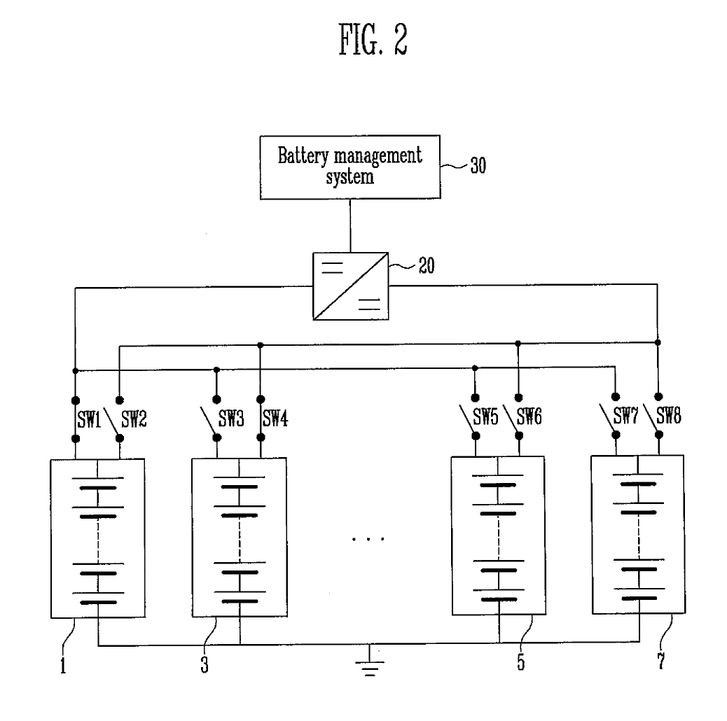

FIG. 2 illustrates charging and discharging operations of a battery unit shown in FIG. 1.

Referring to FIG. 2, a battery management system 30 ma_{y} control a DC-DC converter 20 and a switch unit (e.g., switch units SW1-SW8) such that two battery units of a plurality of battery units 1, 3, 5, and 7 are respectively charged and discharged, or respectively discharged and charged, as electrical energy moves between the two battery units.

In controlling the switch unit so that the battery units may supply and receive electrical energy between them, the battery management system 30 may control the switch units respectively coupled to the battery units that are to supply and receive electrical energy to turn them on, but may control the switch units so that only one of two switch units coupled to each of the battery units, respectively, is turned on/closed.

As for a battery unit that is discharged by releasing stored electrical energy, the battery management system 30 may control the switch units such that switch units SW1, SW3, SW5, and SW7 coupled to one end of the DC-DC converter 20 are turned on. As for a battery unit that is charged by receiving electrical energy, the battery management system 30 may control the switch units such that any one of switch units SW2, SW4, SW6, and SW8 coupled to the other end of the DC-DC converter 20 is turned on.

For example, the battery management system 30 may output a control signal such that the switch units SW1 and SW4 are turned on when electrical energy moves from a first battery unit 1 to a second battery unit 3. When the switch units SW1 and SW4 are turned on due to the control signal of the battery management system 30, the first and second battery units 1 and 3 may be coupled through the DC-DC converter 20, and electrical energy stored in the first battery unit 1 may move to the second battery unit 3.

Although electrical energy is described as moving between two battery units 1 and 3 with reference to FIG. 2, the present invention is not limited hereto. The battery management system 30 may control the switch units such that electrical energy may move between 3 or more of the battery units 1, 3, 5, and 7. For example, if the battery management system 30 controls the switch units such that the second battery unit 3 is further charged by receiving electrical energy stored in battery unit 5, the battery management system 30 may simultaneously control charging and discharging of battery units 1, 3 and 5 by turning on the switch units SW1, SW4, and SW5.

In an embodiment, the plurality of battery units 1, 3, 5, and 7 remain in an idle state for more than a reference time T, and if there is a battery unit among the plurality of battery units 1, 3, 5, and 7 having a SOC value that is included in a SOC range, the battery management system 30 may identify that battery unit as a first battery unit, and may select a second battery unit that is charged by receiving electrical energy from the first battery unit such that the SOC value of the first battery unit is out of the SOC range, or may select the second battery unit to be discharged by transferring electrical energy to the first battery unit.

The battery management system 30 may transfer electrical energy from the first battery unit to the second battery unit such that that the SOC value of the first battery unit is out of the SOC range, or may calculate a movement amount of the electrical energy that the first battery unit is to receive from the second battery unit. Here, the battery management system 30 may refer to information such as the SOC value of the first battery unit, the SOC value of the second battery unit, and whether electrical energy stored in the first battery unit or the second battery unit when electrical energy is moved will be 0.

The battery management system 30 may transfer electrical energy from the second battery unit such that the SOC value of the first battery unit is out of the SOC range, or may transfer electrical energy to the second battery unit. The battery management system 30 may calculate the movement amount of electrical energy such that the changed SOC value of the second battery unit is outside of the SOC range after the electrical energy moves between the first battery unit and the second battery unit.

The battery management system 30 may control the switch units such that electrical energy moves from the first battery unit to the second battery unit to prevent the SOC value of the second battery unit from becoming 0% when electrical energy stored in the second battery unit is smaller than the movement amount of electrical energy.

If there are at least two first battery units (e.g., a plurality of first battery units) having SOC values included in the SOC range among the plurality of battery units 1, 3, 5, and 7, the battery management system 30 may control the switch units such that the plurality of first battery units supply and receive electrical energy such that the SOC value of the plurality of first battery units is out of the SOC range. For example, when the idle state of the battery unit persists to exceed the reference time T, and when there are two first battery units 1 and 3 each having 50% as a SOC value, the battery management system 30 may control the switch units such that electrical energy moves from the first battery unit 1 to the other first battery unit 3 by turning on the switch unit SW1 coupled to the first battery unit 1 and by turning on the switch unit SW4 coupled to the other first battery unit 3. The battery management system 30 may control the switch units such that the SOC values of the two first battery units 1 and 3 are out of the SOC range by having the SOC value of the first battery unit 1 be 25% and by having the SOC value of the other first battery unit 3 be 75% after moving electrical energy.

The battery management system 30 may select a battery unit whose SOC value is not included in the SOC range as a second battery unit for receiving electrical energy from the first battery unit, or may select a second battery unit that is to transfer electrical energy to the first battery unit. While the battery management system 30 may improve life of the first battery unit by controlling the switch units such that the SOC value of the first battery unit is out of the SOC range, it may also improve life of the second battery unit by the movement of electrical energy.

As described later with reference to FIG. 3, life may be improved in the idle state if the SOC value of the battery unit is either high capacity or low capacity. The second battery unit may make the SOC value closer to high capacity, or may transfer electrical energy to the first battery unit such that the SOC value is made closer to low capacity, thereby improving life when in the idle state. For example, if a first battery unit has a SOC value of 45%, and if there is a second battery unit having a SOC value of 85%, after selecting the second battery unit, the SOC value of the first battery unit may be controlled to be 30%, and the SOC value of the second battery unit may be controlled to be 100%, thereby improving life of both the first battery unit and the second battery unit.

In another embodiment, if an idle state of a plurality of battery units 1, 3, 5, and 7 persists to exceed the reference time T, and if there is a first battery unit having a SOC value that is included in a SOC range, a battery management system 30 may select a second battery unit that is to receive electrical energy stored in the first battery unit so that the SOC value of the first battery unit may be out of the SOC range. Here, a battery unit having a smallest SOC value among the other battery units (not including the first battery unit) may be selected as the second battery unit.

However, even if the battery unit having the smallest SOC value among the battery units may be selected as the second battery unit, if there is a battery unit having a SOC value that is close to 100% (not including the first battery unit), then an amount of electrical energy to be delivered may be greater than a remaining storage capacity of the second battery unit, such that the SOC value of the first battery unit is out of the SOC range. Here, electrical energy of the first battery unit may be moved such that the SOC value of the second battery unit becomes 100%, and another second battery unit that is to receive electrical energy of the first battery unit may be re-selected by recalculating a SOC value. That is, a battery unit having a smallest SOC value among battery units (not including the first battery unit, which has a SOC value of 100%) may be re-selected as a second battery unit.

In another embodiment, if idle state of a plurality of battery units persist to exceed the reference time T, and if there is a first battery unit having a SOC value that is included in the SOC range, a battery management system 30 may select a second battery unit that is to transfer electrical energy to the first battery unit such that the SOC value of the first battery unit is out of the SOC range. Here, a battery unit having a greatest SOC value among battery units (not including the first battery unit) may be selected as the second battery unit. Here, the SOC value of the second battery unit may be controlled such that it is greater than 0 after charging and discharging are controlled.

FIG. 3 compares battery units having different SOC values, and illustrates a state in which life of a battery unit changes as an idle state of a battery unit is prolonged.

A horizontal axis of a graph illustrated in FIG. 3 is related to an idle state time t (storage time in days) during which an idle state persists, and a vertical axis of the graph is related to a capacity recovery rate of a battery unit. Referring to FIG. 3, as the idle state of the battery unit is prolonged, the recovery rate of the battery unit decreases. However, if the idle state of a battery unit having a SOC value of 50% persists, the recovery rate may rapidly decrease in the event that the idle state of a battery unit having a different SOC value persists.

On the other hand, if an idle state of a high capacity battery unit having a SOC value of 80% or greater persists, the recovery rate may decrease at a relatively slower rate when compared to the idle state of the battery unit having the SOC value of 50%. Particularly, for battery units having SOC values close to 100%, the rate at which the capacity recovery rate decreases may decrease more and more (e.g., may decrease exponentially). Referring to FIG. 3, if an idle state of low capacity battery unit having a SOC value of 20% or less persists, the capacity recovery rate may decrease at a relatively lower rate than the capacity recovery rate of a battery unit having a SOC value of 50%. Particularly, for battery units having SOC values close to 10%, the rate at which the recovery rate decreases may decrease more and more (e.g., the recovery rate of the battery unit having a SOC value close to 10% decreases much less than battery units having a SOC value of 50%).

If the idle state of a battery unit persists, life of the battery unit may change depending on a SOC value of the battery unit. The longer the idle state, the greater the difference in life between battery units having different SOC values.

Consequently, if the idle state of a battery unit persists, to prevent life of the battery unit from being rapidly deteriorated, it may be necessary to adjust the SOC value of the battery unit. The battery management system may set the SOC range to correspond to a range in which the recovery rate decreases the fastest, and may control the switch units such that the SOC value of the battery unit may be out of the section. Particularly, the battery management system may control the SOC value of the battery unit such that it may be out of the scope, 50±Δ(%), which is where life of the battery unit decreases the fastest, thereby preventing life of the battery unit from rapidly decreasing. However, as described above, not only is the life of the battery unit considered, but performance of a battery pack when an operation of the battery unit commences is also considered, and the SOC value may be controlled such that it does not become 0.

The battery management system 30 may monitor a battery unit, and if a SOC value of the battery unit is included in a SOC range when idle state of the battery unit exceeds the reference time (e.g., if the SOC value of the battery unit is included in a scope/range where life of the battery unit rapidly decreases), the battery management system 30 may adjust the SOC value by charging or discharging the battery unit, thereby improving life of the battery unit. Furthermore, because electrical energy moves between battery units, an entire amount of energy of the battery pack may be maintained in a consistent manner.

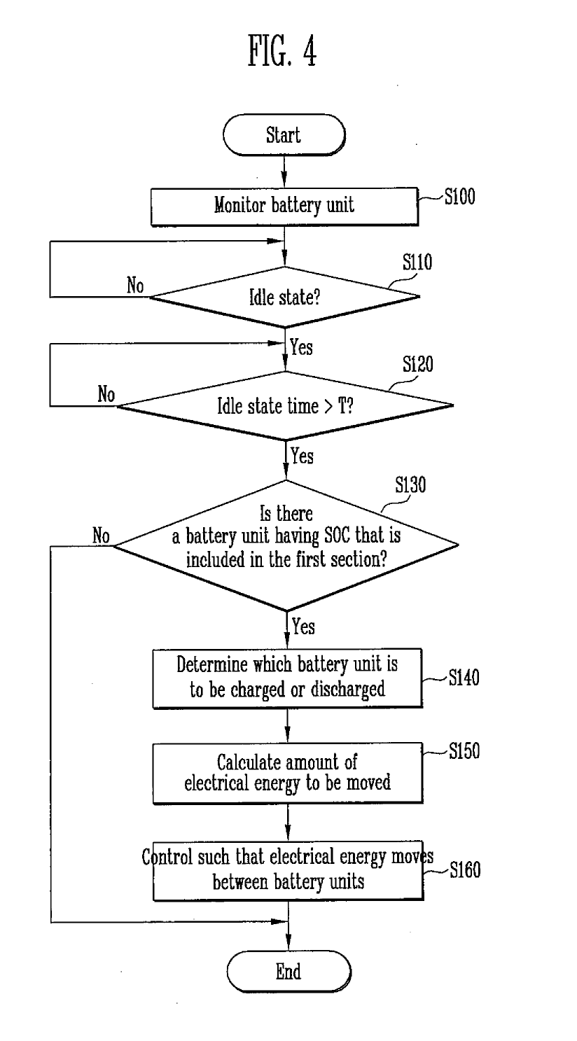

FIG. 4 is a flow chart illustrating an overall flow of a method for controlling a battery pack according to an embodiment.

Referring to FIG. 4, a battery management system according to an embodiment may monitor each of the battery units (S100). The battery management system may calculate a SOC value of each of the battery units from a data value obtained from monitoring the battery units (for example, the flow of the charging current and discharging current of the battery unit, voltage, temperature, and the like) and may determine whether the battery unit is in an action state or idle state.

If the battery unit is in the idle state, the battery management system may measure the idle state time t (i.e., a time during which the idle state persists), and may compare the measured t with reference time T (S110 and S120).

If the battery management system determines that the measured time t is greater than the reference time T, the battery management system may determine which battery unit among a plurality of battery units has a SOC value that is included in the SOC range (50±Δ(%)) (S130).

If there is a first battery unit having a SOC value that is included in the SOC range, the battery management system may transfer electrical energy stored in the first battery unit, or may select a second battery unit that is to transfer electrical energy to the first battery unit, such that the SOC value of the first battery unit is taken out of the SOC range (S140).

The battery management system may calculate an amount of electrical energy that is to be transferred to the second battery unit from the first battery unit, or that is to be received from the second battery unit to be transferred to the first battery unit, such that the SOC value of the first battery unit is moved out of the SOC range (S150).

Then, the battery management system may control charging and discharging of the battery units such that electrical energy moves between respective ones of the battery units (S160).

By way of summation and review, if idle state time t of a battery unit exceeds a reference time T, charging and discharging of the battery units may be controlled such that the SOC value of each battery unit is out of a SOC range, thereby improving life of the battery. If charging and discharging of a battery unit are controlled, electrical energy may move between respective ones of the battery units provided in a battery pack, thereby reducing or minimizing loss of energy, and thereby improving life of the battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a plurality of rechargeable battery units; and
a battery management system configured to:
control charging and discharging of the plurality of battery units;
calculate an idle state time of the plurality of battery units by monitoring the plurality of battery units;
determine whether a state of charge (SOC) value of a first battery unit of the battery units is within a SOC range; and
cause electrical energy to move from the first battery unit to a second battery unit of the battery units, or to move from the second battery unit to the first battery unit, when the idle state time exceeds a reference time, such that SOC values of the first battery unit and the second battery unit are outside of the SOC range.

2. The battery pack as claimed in claim 1, further comprising:
a plurality of switch units coupled to respective ones of the plurality of battery units; and
a direct current-to-direct current (DC-DC) converter coupled to at least one of the battery units through the switch unit.

3. The battery pack as claimed in claim 2, wherein the battery management system is further configured to:
control the DC-DC converter; and
control the switch units to cause the electrical energy to move between the first battery unit and the second battery unit.

4. The battery pack as claimed in claim 3, wherein the battery management system is further configured to control the switch units such that a first switch unit of the switch units that is coupled to the first battery unit and that is coupled to a first end of the DC-DC converter, and such that a second switch unit of the switch units that is coupled to the second battery unit and that is coupled to a second end of the DC-DC converter, are turned on to cause the electrical energy to move between the first battery unit and the second battery unit.

5. The battery pack as claimed in claim 1, wherein the battery management system is further configured to cause the electrical energy to move from the first battery unit to the second battery unit, or to move from the second battery unit to the first battery unit, after determining that the SOC value of the first battery unit is within the SOC range.

6. The battery pack as claimed in claim 5, wherein the battery management system is further configured to calculate a movement amount of the electrical energy that is to be transferred between the first battery unit and the second battery unit.

7. The battery pack as claimed in claim 5, wherein the battery management system is further configured to select any one of the plurality of battery units having a SOC value outside of the SOC range as the second battery unit.

8. The battery pack as claimed in claim 1, wherein the battery management system is further configured to:
select a battery unit of the plurality of battery units having a smallest SOC value as the second battery unit; and
cause the electrical energy to move from the first battery unit to the second battery unit after determining that the SOC value of the first battery unit is within the SOC range.

9. The battery pack as claimed in claim 8, wherein the battery management system is further configured to:
re-calculate the SOC value of each of the battery units when the SOC value of the first battery unit continues to be within the SOC range after causing the electrical energy to move from the first battery unit to the second battery unit when the second battery unit is fully charged; and
re-select a remaining battery unit of the battery units having a smallest SOC value not within the SOC range as the second battery unit.

10. The battery pack as claimed in claim 1, wherein the battery management system is further configured to:
select a battery unit of the battery units having a largest SOC value as the second battery unit; and
cause the electrical energy to move from the second battery unit to the first battery unit after determining that the SOC value of the first battery unit is within the SOC range.

11. The battery pack as claimed in claim 6, wherein the battery management system is further configured to cause the electrical energy to move to the second battery unit from the first battery unit when an amount of electrical energy stored in the second battery unit is the same or smaller than the calculated movement amount of the electrical energy.

12. The battery pack as claimed in claim 1, wherein the battery management system is further configured to cause the electrical energy to move between ones of the battery units having SOC values within the SOC range.

13. A method of controlling a battery pack comprising a plurality of rechargeable battery units, and a battery management system configured to control charging and discharging of the battery units, the method comprising:
determining whether the plurality of battery units are in an idle state by monitoring the plurality of battery units;
determining whether one of the battery units has a SOC value within a SOC range; and
controlling charging and discharging of the battery units after determining that the one of the battery units has the SOC value within the SOC range by moving electrical energy between the one of the battery units and respective ones of the battery units such that a SOC value of each of the battery units is out of the SOC range when an idle state time of the plurality of battery units exceeds a reference time.
